(19) United States
(12) Patent Application Publication
(10) Pub. No.: US 2026/0171680 A1
(43) Pub. Date: Jun. 18, 2026

(54) TRANSMISSION AND RECEPTION ARRAY ANTENNA AND COMMUNICATION NODE INCLUDING THE SAME

(71) Applicant: ELECTRONICS AND TELECOMMUNICATIONS RESEARCH INSTITUTE, Daejeon (KR)

(72) Inventors: Bong Hyuk PARK, Daejeon (KR); Sunwoo KONG, Daejeon (KR); Seung Hun WANG, Daejeon (KR); Hui Dong LEE, Daejeon (KR)

(73) Assignee: ELECTRONICS AND TELECOMMUNICATIONS RESEARCH INSTITUTE, Daejeon (KR)

(21) Appl. No.: 19/421,137

(22) Filed: Dec. 16, 2025

(30) Foreign Application Priority Data
Dec. 17, 2024 (KR) 10-2024-0188709

(51) Int. Cl. H01Q 21/06; H01Q 1/24

(52) U.S. Cl. CPC H01Q 21/06; H01Q 1/246

(57) ABSTRACT

A transmission and reception array antenna may comprise: a plurality of transmission antenna elements and a plurality of reception antenna elements disposed on a first surface of a first substrate; a plurality of transmission beamforming elements disposed on a second surface of the first substrate and connected to the plurality of transmission antenna elements; and a plurality of reception beamforming elements disposed on a first surface of a second substrate overlapping the first substrate and connected to the plurality of reception antenna elements, the second surface of the first substrate being adjacent to the first surface of the second substrate.

### CROSS-REFERENCE TO RELATED APPLICATIONS

This application claims priority to Korean Patent Applications No. 10-2024-0188709, filed on Dec. 17, 2024, with the Korean Intellectual Property Office (KIPO), the entire contents of which are hereby incorporated by reference.

### BACKGROUND

### 1. Technical Field

The present disclosure relates to a technique for transmission and reception antennas, and more particularly, to a transmission and reception antenna technique for arranging a transmission array antenna and a reception array antenna on the same plane.

### 2. Related Art

In order to handle the rapidly increasing volume of wireless data, not only a frequency band (e.g. a frequency band of 6 GHz or lower) of a 4G communication system, but also a frequency band (e.g. a frequency band of 6 GHz or higher) higher than that of the 4G communication system may be used in a 5G communication system (e.g. New Radio (NR) communication system)

The NR communication system may provide communication services to terminals located on the ground (terrestrial). Recently, demand for communication services for unmanned aerial vehicles (UAVs), unmanned aerial network (UAN) base stations (UBSs), and satellites, which are located not only on the ground but also in non-terrestrial spaces, has been increasing, and technologies for non-terrestrial networks (NTNs) are being discussed.

In a non-terrestrial network using a satellite, a ground communication node (e.g. a terminal) may include a baseband modem, radio-frequency (RF) elements, and antennas for communication with the satellite. The RF elements of the communication node may include a transmission beamforming chip and a reception beamforming chip, and the antennas may include a transmission array antenna and a reception array antenna. The RF elements and the antennas may be configured using a frequency division duplex (FDD) scheme.

Meanwhile, in conventional ground communication nodes, a transmission array antenna and a reception array antenna may be configured as separate devices and may be disposed at different locations. This may increase the size and weight of the communication node, and therefore, a new arrangement structure for the transmission array antenna and the reception array antenna is required.

### SUMMARY

The present disclosure for resolving the above-described problems is directed to providing a transmission and reception array antenna in which transmission antenna elements and reception antenna elements are arranged on the same plane.

According to a first exemplary embodiment of the present disclosure, a transmission and reception array antenna may comprise: a plurality of transmission antenna elements and a plurality of reception antenna elements disposed on a first surface of a first substrate; a plurality of transmission beamforming elements disposed on a second surface of the first substrate and connected to the plurality of transmission antenna elements; and a plurality of reception beamforming elements disposed on a first surface of a second substrate overlapping the first substrate and connected to the plurality of reception antenna elements, the second surface of the first substrate being adjacent to the first surface of the second substrate.

The transmission and reception array antenna may further comprise: a plurality of contact holes formed in the first substrate, wherein each of the plurality of transmission beamforming elements may be disposed to overlap at least one of the plurality of transmission antenna elements, and the plurality of contact holes may connect each of the plurality of transmission beamforming elements and each of the plurality of transmission antenna elements.

The transmission and reception array antenna may further comprise: a plurality of through-holes formed at corresponding positions of the first substrate and the second substrate; and a plurality of pogo pins each of which is inserted into each of the plurality of through-holes, wherein each of the plurality of reception beamforming elements may be disposed to overlap at least one of the plurality of reception antenna elements, and the plurality of pogo pins may connect each of the plurality of reception beamforming elements and each of the plurality of reception antenna elements.

The plurality of transmission antenna elements may be disposed on the first surface of the first substrate at a first interval, the plurality of reception antenna elements may be disposed on the first surface of the first substrate at a second interval, and the plurality of reception antenna elements may be disposed so as not to overlap the plurality of transmission antenna elements.

The plurality of transmission antenna elements may operate in a frequency band different from a frequency band of the plurality of reception antenna elements.

According to a second exemplary embodiment of the present disclosure, a communication node may comprise a transmission and reception array antenna for transmitting and receiving beams with a satellite, wherein the transmission and reception array antenna may comprise: a plurality of transmission antenna elements and a plurality of reception antenna elements disposed on a first surface of a first substrate; a plurality of transmission beamforming elements disposed on a second surface of the first substrate and connected to the plurality of transmission antenna elements; and a plurality of reception beamforming elements disposed on a first surface of a second substrate overlapping the first substrate and connected to the plurality of reception antenna elements, the second surface of the first substrate being adjacent to the first surface of the second substrate.

The transmission and reception array antenna may further comprise: a plurality of contact holes formed in the first substrate, wherein each of the plurality of transmission beamforming elements may be disposed to overlap at least one of the plurality of transmission antenna elements, and the plurality of contact holes may connect each of the plurality of transmission beamforming elements and each of the plurality of transmission antenna elements.

The transmission and reception array antenna may further comprise: a plurality of through-holes formed at corresponding positions of the first substrate and the second substrate; and a plurality of pogo pins each of which is inserted into each of the plurality of through-holes, wherein each of the plurality of reception beamforming elements may be disposed to overlap at least one of the plurality of reception antenna elements, and the plurality of pogo pins may connect each of the plurality of reception beamforming elements and each of the plurality of reception antenna elements.

The plurality of transmission antenna elements may be disposed on the first surface of the first substrate at a first interval, the plurality of reception antenna elements may be disposed on the first surface of the first substrate at a second interval, and the plurality of reception antenna elements may be disposed so as not to overlap the plurality of transmission antenna elements.

The plurality of transmission antenna elements may operate in a frequency band different from a frequency band of the plurality of reception antenna elements.

According to the present disclosure, a transmission/reception array antenna may be configured by disposing a plurality of transmission antenna elements and a plurality of reception antenna elements on the same plane of a substrate so as not to overlap each other. Accordingly, a size of a communication node including the transmission/reception array antenna may be reduced.

In addition, according to the present disclosure, the transmission/reception array antenna may be configured by linearly disposing the plurality of transmission antenna elements and the plurality of reception antenna elements at uniform intervals on the same plane of the substrate. Accordingly, the transmission/reception array antenna can perform beam steering in upward, downward, leftward, and rightward directions.

### BRIEF DESCRIPTION OF DRAWINGS

FIG. 1 is a conceptual diagram illustrating a first exemplary embodiment of a communication network.

FIG. 2 is a diagram illustrating a second exemplary embodiment of a communication network.

FIG. 3 is a diagram illustrating a third exemplary embodiment of a communication network.

FIG. 4 is a block diagram illustrating an exemplary embodiment of a communication node constituting a communication network.

FIG. 5 is a conceptual diagram illustrating a first exemplary embodiment of a transmission/reception array antenna.

FIG. 6A is a side perspective view of the transmission/reception array antenna of FIG. 5.

FIG. 6B is a cross-sectional view obtained by cutting the transmission/reception array antenna of FIG. 5 along a line VI-VI′.

FIG. 7A is an enlarged cross-sectional view of a portion A of FIG. 6.

FIG. 7B is an enlarged cross-sectional view of a portion B of FIG. 6.

FIG. 8 is a conceptual diagram illustrating a second exemplary embodiment of a transmission/reception array antenna.

FIG. 9A is a side perspective view of the transmission/reception array antenna of FIG. 8.

FIG. 9B is a cross-sectional view obtained by cutting the transmission/reception array antenna of FIG. 8 along a line IX-IX′.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e. “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system may be the 4G communication system (e.g. Long-Term Evolution (LTE) communication system or LTE-A communication system), the 5G communication system (e.g. New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, the expression “an operation (e.g. a transmission operation) is configured to a communication node” may indicate that configuration information for the operation (e.g. one or more information elements or parameters) and/or information instructing the communication node to perform the operation is signaled to the communication node. In this regard, the expression may also indicate that the communication node receives the configuration information and/or the instruction information. The expression “information element(s) (e.g. parameter(s)) are configured to a communication node” may indicate that the corresponding information element(s) are signaled to the communication node, that is, the communication node receives the information element(s). The signaling may be performed through at least one of system information (SI) signaling (e.g. transmission of a system information block (SIB) and/or a master information block (MIB)), RRC signaling (e.g. transmission of RRC parameters and/or higher layer parameters), MAC control element (CE) signaling, and PHY signaling (e.g. transmission of downlink control information (DCI), uplink control information (UCI), and/or sidelink control information (SCI)).

Hereinafter, even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

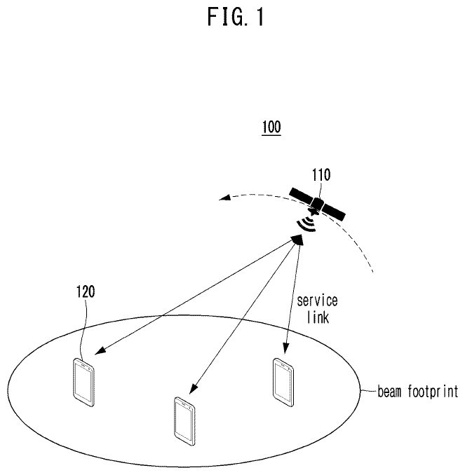

FIG. 1 is a conceptual diagram illustrating a first exemplary embodiment of a communication network.

Referring to FIG. 1, a communication network 100 of the present exemplary embodiment may be a non-terrestrial network. The communication network 100 may include a satellite 110 and a plurality of communication nodes 120.

The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS).

The plurality of communication nodes 120 may include a communication node located on the ground and a communication node located in a non-terrestrial space. The communication node located on the ground may be a user equipment (UE) or a terminal. The communication node located in a non-terrestrial space may be an airplane or a drone.

A service link may be established between the satellite 110 and the communication node 120. The service link may be a radio link. The satellite 110 may provide a communication service to the communication node 120 by using one or more beams. A footprint of the beam of the satellite 110 may be elliptical. One of beam footprints of the satellite 110 may have a range of 500˜1,000 km, and the plurality of communication nodes 120 may be located within one footprint.

The communication node 120 may perform downlink communication or uplink communication with the satellite 110 by using LTE technology or NR technology. Communication between the satellite 110 and the communication node 120 may be performed through an NR-Uu interface. When dual connectivity (DC) is supported, the communication node 120 may be connected not only to the satellite 110 but also to another base station (e.g. base station supporting LTE or NR functions), and may perform DC operations based on technologies defined in LTE or NR specifications.

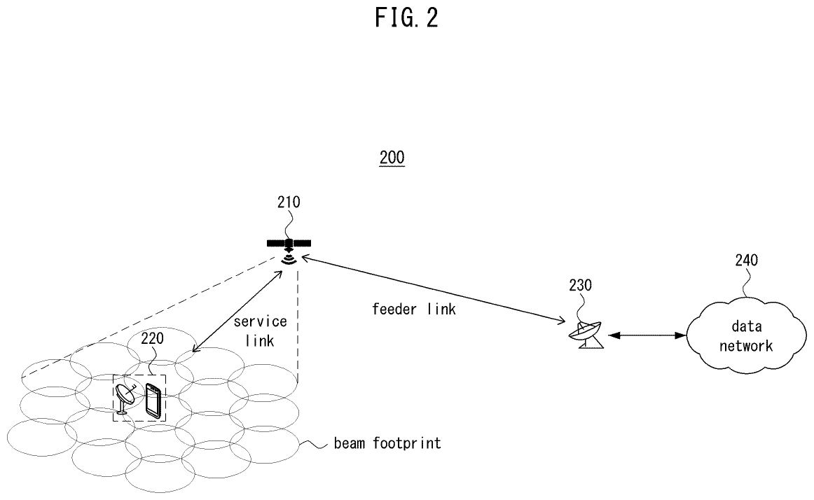

FIG. 2 is a diagram illustrating a second exemplary embodiment of a communication network.

Referring to FIG. 2, a communication network 200 of the present exemplary embodiment may be a non-terrestrial network. The non-terrestrial network may include a satellite 210, a communication node 220, a gateway 230, and a data network 240. The non-terrestrial network of FIG. 2 may be a non-terrestrial network based on a transparent payload.

The satellite 210 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS).

The communication node 220 may include communication nodes located on the ground and communication nodes located in a non-terrestrial space. The communication node located on the ground may be a user equipment (UE) or a terminal. The communication node located in the non-terrestrial space may be an airplane or a drone.

A service link may be established between the satellite 210 and the communication node 220. The service link may be a radio link. The satellite 210 may provide communication services to the communication node 220 by using one or more beams. A footprint of a beam of the satellite 210 may be elliptical. One of the beam footprints of the satellite 210 may have a range of 500 to 1,000 km, and a plurality of communication nodes 220 may be located in one beam footprint.

The communication node 220 may perform downlink communication or uplink communication with the satellite 210 using LTE technology and/or NR technology. The communications between the satellite 210 and the communication node 220 may be performed using an NR-Uu interface. When dual connectivity (DC) is supported, the communication node 220 may be connected to another base station supporting LTE and/or NR functionality as well as the satellite 210, and perform DC operations based on the techniques defined in the LTE and/or NR specifications.

The gateway 230 may be located on a terrestrial site, and a feeder link may be established between the satellite 210 and the gateway 230. The feeder link may be a radio link. The gateway 230 may be referred to as a ‘non-terrestrial network (NTN) gateway’. The communications between the satellite 210 and the gateway 230 may be performed based on an NR-Uu interface or a satellite radio interface (SRI). The gateway 230 may be connected to the data network 240.

There may be a ‘core network’ between the gateway 230 and the data network 240. In this case, the gateway 230 may be connected to the core network, and the core network may be connected to the data network 240. The core network may support the NR technology. For example, the core network may include an access and mobility management function (AMF), a user plane function (UPF), a session management function (SMF), and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and core network may support the NR technology. The communications between the gateway 230 and the base station may be performed based on an NR-Uu interface, and the communications between the base station and the core network may be performed based on an NG-C/U interface.

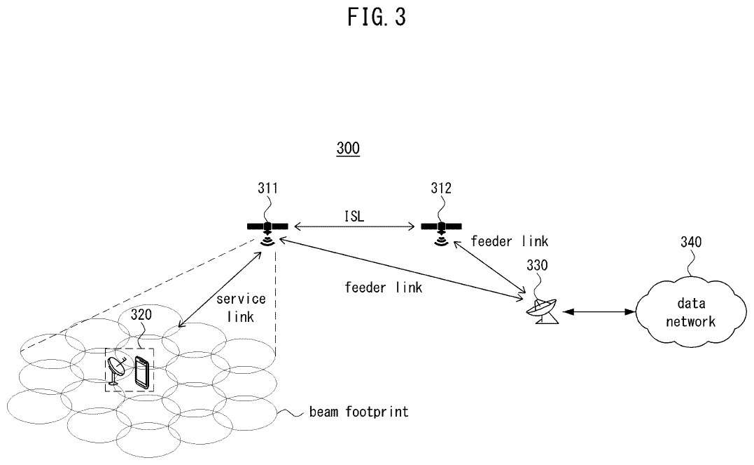

FIG. 3 is a diagram illustrating a third exemplary embodiment of a communication network.

Referring to FIG. 3, a communication network 300 of the present exemplary embodiment may be a non-terrestrial network. The non-terrestrial network may include a first satellite 311, a second satellite 312, a communication node 320, a gateway 330, and a data network 340.

The non-terrestrial network of FIG. 3 may be a regenerative payload based NTN. For example, each of the first satellite 311 and the second satellite 312 may perform a regenerative operation on a payload received from other entities (e.g. the communication node 320 or the gateway 330), and transmit the regenerated payload. Here, the regenerative operation may include demodulation, decoding, re-encoding, re-modulation, and/or filtering operations.

Each of the first satellite 311 and the second satellite 312 may be a LEO satellite, a MEO satellite, a GEO satellite, a HEO satellite, or a UAS platform. The UAS platform may include a HAPS. The first satellite 311 may be connected to the second satellite 312, and an inter-satellite link (ISL) may be established between the first satellite 311 and the second satellite 312. The ISL may operate in an RF frequency band or an optical band. The ISL may be established optionally.

The communication node 320 may include a communication node located on the ground and a communication node located in a non-terrestrial space. The communication node located on the ground may be a user equipment (UE) or a terminal. The communication node located in the non-terrestrial space may be an airplane or a drone.

A service link may be established between the first satellite 311 and the communication node 320. The service link may be a radio link. The first satellite 311 may provide communication services to the communication node 320 using one or more beams. A footprint of a beam of the first satellite 311 may be elliptical.

The communication node 320 may perform downlink communication or uplink communication with the first satellite 311 using LTE technology and/or NR technology. The communications between the first satellite 311 and the communication node 320 may be performed using an NR-Uu interface. When DC is supported, the communication node 320 may be connected to another base station supporting LTE and/or NR functionality as well as the first satellite 311, and may perform DC operations based on the techniques defined in the LTE and/or NR specifications.

The gateway 330 may be located on a terrestrial site, a feeder link may be established between the first satellite 311 and the gateway 330, and a feeder link may be established between the second satellite 312 and the gateway 330. The feeder link may be a radio link. When the ISL is not established between the first satellite 311 and the second satellite 312, the feeder link between the first satellite 311 and the gateway 330 may be established mandatorily. The communications between each of the first satellite 311 and the second satellite 312 and the gateway 330 may be performed based on an NR-Uu interface or an SRI.

The gateway 330 may be connected to the data network 340. There may be a core network between the gateway 330 and the data network 340. In this case, the gateway 330 may be connected to the core network, and the core network may be connected to the data network 340. The core network may support the NR technology. For example, the core network may include AMF, UPF, SMF, and the like. The communications between the gateway 330 and the core network may be performed based on an NG-C/U interface.

Alternatively, a base station and the core network may exist between the gateway 330 and the data network 340. In this case, the gateway 330 may be connected with the base station, the base station may be connected with the core network, and the core network may be connected with the data network 340. The base station and the core network may support the NR technology. The communications between the gateway 330 and the base station may be performed based on an NR-Uu interface, and the communications between the base station and the core network may be performed based on an NG-C/U interface.

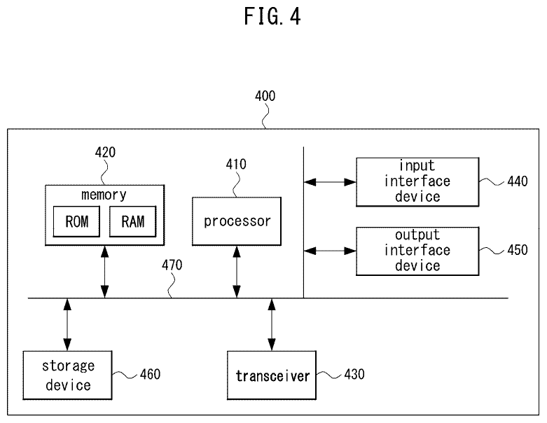

FIG. 4 is a block diagram illustrating an exemplary embodiment of a communication node constituting a communication network.

Referring to FIG. 4, a communication node 400 may include at least one processor 410, a memory 420, and a transceiver 430 connected to a network to perform communication. In addition, the communication node 400 may further include an input interface device 440, an output interface device 450, a storage device 460, and the like. The components included in the communication node 400 may be connected by a bus 470 to communicate with each other.

However, each component included in the communication node 400 may be connected to the processor 410 through a separate interface or a separate bus instead of the common bus 470. For example, the processor 410 may be connected to at least one of the memory 420, the transceiver 430, the input interface device 440, the output interface device 450, and the storage device 460 through a dedicated interface.

The processor 410 may execute at least one instruction stored in at least one of the memory 420 and the storage device 460. The processor 410 may refer to a central processing unit (CPU), a graphics processing unit (GPU), or a dedicated processor on which the methods according to the exemplary embodiments of the present disclosure are performed.

Each of the memory 420 and the storage device 460 may be configured as at least one of a volatile storage medium and a nonvolatile storage medium. For example, the memory 420 may be configured with at least one of a read only memory (ROM) and a random access memory (RAM).

The transceiver 430 may include devices for communication with the satellite in the communication network described with reference to FIG. 1 to FIG. 3, for example, at least one RF element, a transmission array antenna connected to the at least one RF element, and a reception array antenna connected to the at least one RF element. In addition, the transmission array antenna may include at least one transmission antenna element, and the reception array antenna may include at least one reception antenna element. The at least one RF element may include at least one transmission beamforming element each of which is connected to transmission antenna elements and at least one reception beamforming element each of which is connected to reception antenna elements.

Meanwhile, in a conventional transceiver, the transmission array antenna and the reception array antenna may be configured as separate devices and may be disposed at different locations. This may increase a size of the transceiver and a size of the communication node 400 including the transceiver. Therefore, a new arrangement method of the transmission array antenna and the reception array antenna may be required to reduce the size of the communication node 400.

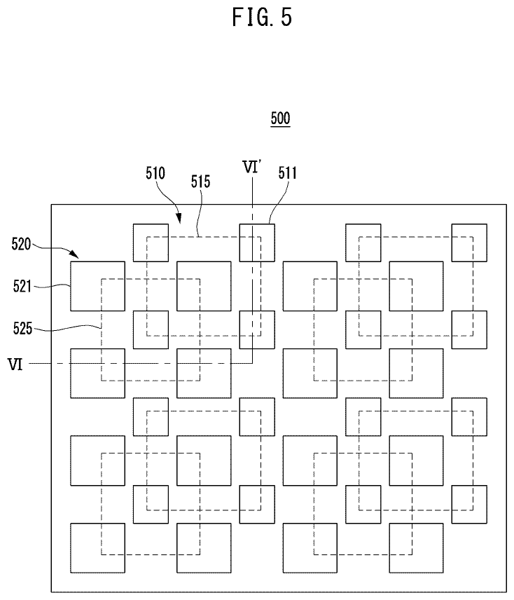

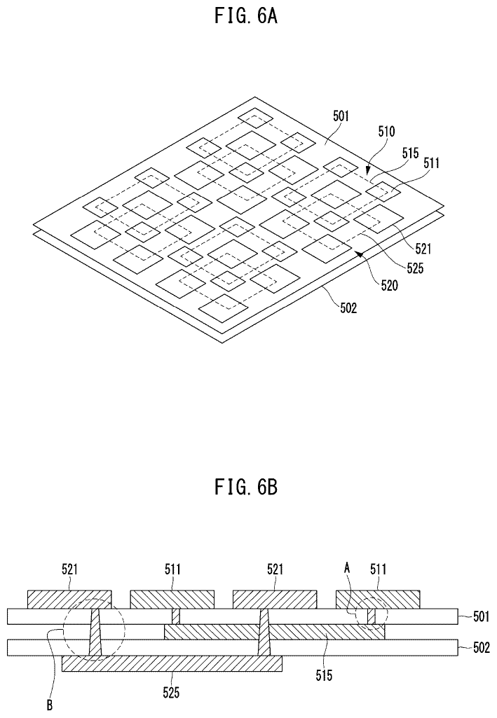

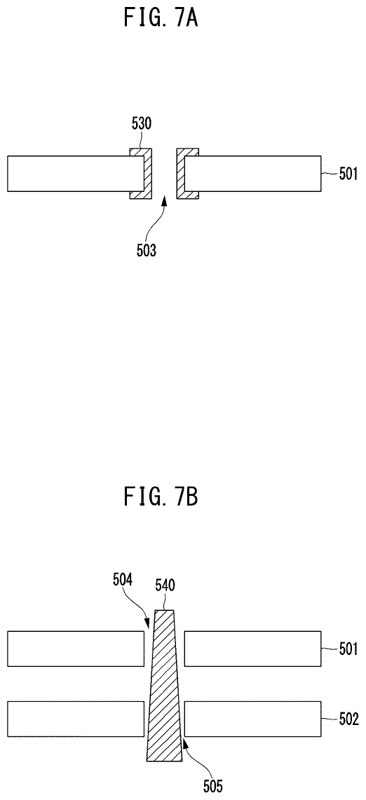

FIG. 5 is a conceptual diagram illustrating a first exemplary embodiment of a transmission/reception array antenna, FIG. 6A is a side perspective view of the transmission/reception array antenna of FIG. 5, and FIG. 6B is a cross-sectional view obtained by cutting the transmission/reception array antenna of FIG. 5 along a line VI-VI′. In addition, FIG. 7A is an enlarged cross-sectional view of a portion A of FIG. 6, and FIG. 7B is an enlarged cross-sectional view of a portion B of FIG. 6.

Referring to FIG. 5, FIG. 6A, and FIG. 6B, a transmission/reception array antenna 500 of the present exemplary embodiment may be included in the communication node 400 that transmits and receives a signal, for example, a beam, with the satellite, and may include a plurality of transmission antenna elements 511 and a plurality of reception antenna elements 521 for beam transmission and reception. In addition, the transmission/reception array antenna 500 may include a plurality of transmission beamforming elements 515 each of which is connected to corresponding ones of the plurality of transmission antenna elements 511, and a plurality of reception beamforming elements 525 each of which is connected to corresponding ones of the plurality of reception antenna elements 521.

The plurality of transmission antenna elements 511 and the plurality of transmission beamforming elements 515 may configure a transmission array antenna 510. The transmission array antenna 510 may receive a transmission signal subjected to baseband signal processing and may transmit a transmission beam to the satellite through the plurality of transmission antenna elements 511 steered by the plurality of transmission beamforming elements 515.

The plurality of reception antenna elements 521 and the plurality of reception beamforming elements 525 may configure a reception array antenna 520. The reception array antenna 520 may receive a reception beam transmitted from the satellite through the plurality of reception antenna elements 521 steered by the plurality of reception beamforming elements 525.

The plurality of transmission antenna elements 511 and the plurality of reception antenna elements 521 may be disposed on a same plane or same region of a first substrate 501, that is, on one surface of the first substrate 501. The plurality of transmission antenna elements 511 may be uniformly disposed at a first interval (e.g. approximately 0.75 λ). The plurality of reception antenna elements 521 may be uniformly disposed at a second interval (e.g. approximately 0.5 λ), and may be disposed so as not to overlap the plurality of transmission antenna elements 511.

In FIG. 5, as an exemplary embodiment, 16 transmission antenna elements 511 and 16 reception antenna elements 521 are illustrated as being disposed on one surface of the first substrate 501, but the present disclosure is not limited thereto. For example, the number of the plurality of transmission antenna elements 511 and the number of the plurality of reception antenna elements 521 may increase or decrease based on a frequency band used for communication with the satellite.

In addition, each of the plurality of transmission antenna elements 511 and the plurality of reception antenna elements 521 may perform transmission and reception of beams by using different frequency bands. For example, the plurality of transmission antenna elements 511 may use a transmission frequency having a center frequency of approximately 30 GHz, and the plurality of reception antenna elements 521 may use a reception frequency having a center frequency of approximately 20 GHz.

The plurality of transmission beamforming elements 515 may be disposed on the other surface of the first substrate 501. The plurality of transmission beamforming elements 515 may be disposed to overlap placement positions of the plurality of transmission antenna elements 511. As illustrated in FIG. 5, each of the plurality of transmission beamforming elements 515 may be disposed to overlap placement positions of four transmission antenna elements among the plurality of transmission antenna elements 511.

Meanwhile, according to an exemplary embodiment of the present disclosure, each of the plurality of transmission beamforming elements 515 may be disposed on one surface of a second substrate 502 overlapping the first substrate 501, that is, on one surface of the second substrate 502 adjacent to the other surface of the first substrate 501. In this case, each of the plurality of transmission beamforming elements 515 may be disposed to overlap placement positions of corresponding ones of the plurality of transmission antenna elements 511 as described above.

Referring to FIG. 6B and FIG. 7A, each of the plurality of transmission beamforming elements 515 may be connected to each of a plurality of transmission antenna elements through a contact hole. For this purpose, a plurality of contact holes 503 may be formed in regions where the plurality of transmission antenna elements 511 of the first substrate 501 overlap the plurality of transmission beamforming elements 515. Each of the plurality of contact holes 503 may include a conductive pattern 530 formed of a conductive material therein. Each of the plurality of transmission antenna elements 511 may be electrically connected to the corresponding transmission beamforming element through a conductive pattern of a contact hole. The plurality of contact holes 503 may be via holes.

The plurality of reception beamforming elements 525 may be disposed on the other surface of the second substrate 502. Each of the plurality of reception beamforming elements 525 may be disposed to overlap placement position of corresponding ones of the plurality of reception antenna elements 521. As illustrated in FIG. 5, each of the plurality of reception beamforming elements 525 may be disposed to overlap placement positions of four reception antenna elements among the plurality of reception antenna elements 521.

Referring to FIG. 6B and FIG. 7B, each of the plurality of reception beamforming elements 525 may be connected to each of a plurality of reception antenna elements through a pogo pin. For this purpose, a plurality of first through-holes 504 may be formed at positions corresponding to the plurality of reception antenna elements 521 of the first substrate 501, and a plurality of second through-holes 505 may be formed at positions corresponding to the plurality of reception beamforming elements 525 of the second substrate 502. Each of the plurality of first through-holes 504 and each of the plurality of second through-holes 505 may be formed at mutually corresponding positions.

Each of a plurality of pogo pins 540 may be inserted into each of the plurality of first through-holes 504 and each of the plurality of second through-holes 505. Accordingly, each of the plurality of reception antenna elements 521 may be electrically connected to each corresponding reception beamforming element through one of the plurality of pogo pins 540.

As described above, the transmission/reception array antenna 500 of the present exemplary embodiment may dispose the plurality of transmission antenna elements 511 and the plurality of reception antenna elements 521 on the same plane of the first substrate 501, and therefore a size of the communication node 400 including the transmission/reception array antenna 500 can be reduced. In addition, the transmission/reception array antenna 500 of the present exemplary embodiment may linearly dispose the plurality of transmission antenna elements 511 and the plurality of reception antenna elements 521 at a uniform interval on the same plane so as not to overlap each other, and therefore the plurality of transmission antenna elements 511 and the plurality of reception antenna elements 521 can perform beam steering in up, down, left, and right directions by the transmission beamforming elements 515 or the reception beamforming elements 525.

Hereinafter, a method of manufacturing the transmission/reception array antenna 500 of the present disclosure will be described. Placement regions of the plurality of transmission antenna elements 511 and the plurality of reception antenna elements 521 on one surface of the first substrate 501 may be determined. When the placement regions of the antenna elements are determined, each of the plurality of contact holes 503 and each of the plurality of first through-holes 504 may be formed in the first substrate 501.

Each of the plurality of contact holes 503 may be formed to correspond to the placement region of each of the plurality of transmission antenna elements 511. Each of the plurality of first through-holes 504 may be formed to correspond to the placement region of each of the plurality of reception antenna elements 521. Here, each of the plurality of contact holes 503 may be a via hole in which the conductive pattern 530 formed of a conductive material is formed therein. Each of the plurality of first through-holes 504 may be a hole into which a pogo pin to be described below is inserted.

The plurality of transmission beamforming elements 515 may be disposed on the other surface of the first substrate 501. Each of the plurality of transmission beamforming elements 515 may be disposed so as to overlap at least one transmission antenna element. The plurality of transmission beamforming elements 515 may be electrically connected to the plurality of transmission antenna elements 511 through the plurality of contact holes 503.

Next, the second substrate 502 overlapping the first substrate 501 may be prepared. The second substrate 502 may have a same area as the first substrate 501 or a relatively larger area than the first substrate 501. In the second substrate 502, the plurality of second through-holes 505 may be formed to correspond to each of the plurality of first through-holes 504 formed in the first substrate 501 described above. Subsequently, the other surface of the first substrate 501 and one surface of the second substrate 502 may be overlapped, and the plurality of pogo pins 540 may be inserted into respective through-holes among the plurality of first through-holes 504 and the plurality of second through-holes 505 that correspond to each other. Subsequently, the plurality of reception beamforming elements 525 may be disposed on the other surface of the second substrate 502. Each of the plurality of reception beamforming elements 525 may be disposed so as to overlap at least one reception antenna element. Each of the plurality of reception beamforming elements 525 may be electrically connected to each of the plurality of reception antenna elements 521 through each of the plurality of pogo pins 540 described above.

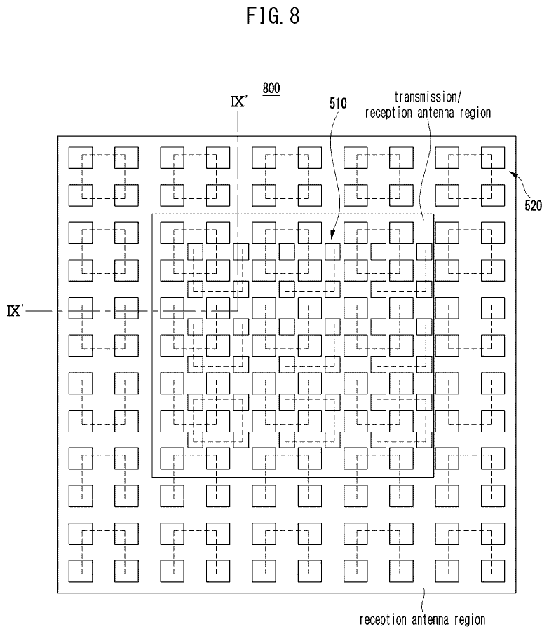

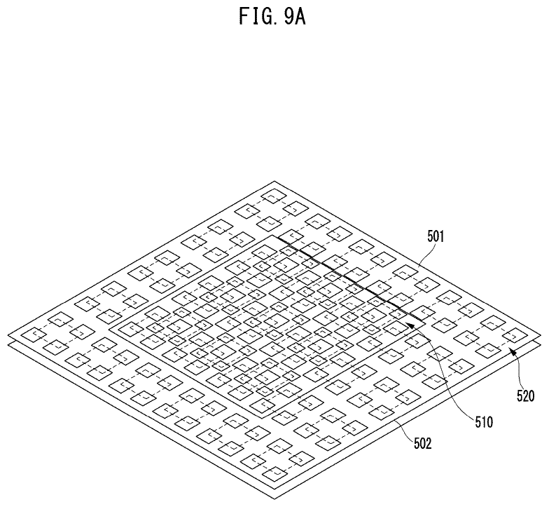

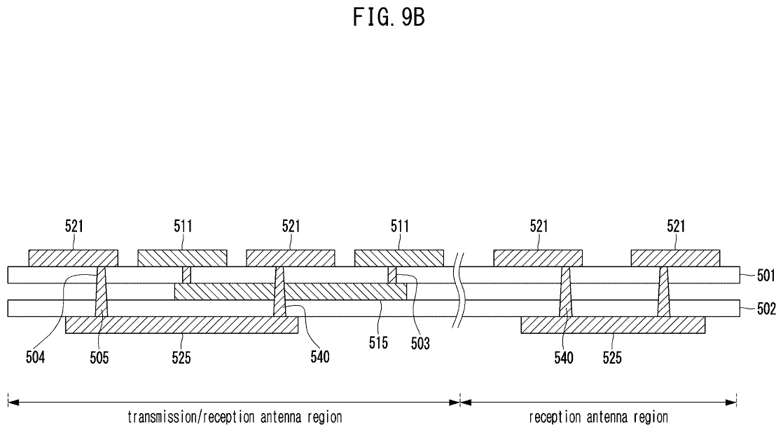

FIG. 8 is a conceptual diagram illustrating a second exemplary embodiment of a transmission/reception array antenna, FIG. 9A is a side perspective view of the transmission/reception array antenna of FIG. 8, and FIG. 9B is a cross-sectional view obtained by cutting the transmission/reception array antenna of FIG. 8 along a line IX-IX′.

A transmission/reception array antenna 800 of the present exemplary embodiment may be applied to communication that uses different transmission and reception frequency bands between the communication node 400 and the satellite in the above-described communication network, for example, frequency division duplex (FDD) communication. The transmission/reception array antenna 800 may include a transmission/reception antenna region including the plurality of transmission antenna elements 511 and a portion of the plurality of reception antenna elements 521 and a reception antenna region including the remaining portion of the plurality of reception antenna elements 521.

Each of the plurality of transmission antenna elements 511 disposed in the transmission/reception antenna region may use a transmission frequency having a center frequency in a band of approximately 30 GHz, and each of the plurality of transmission antenna elements 511 may be uniformly arranged at an interval of approximately 0.75λ. For example, the plurality of transmission antenna elements 511 may be disposed in the transmission/reception antenna region in a number of approximately 900.

In addition, each of the plurality of reception antenna elements 521 disposed in each of the transmission/reception antenna region and the reception antenna region may use a reception frequency having a center frequency in a band of approximately 20 GHz, and each of the plurality of reception antenna elements 521 may be uniformly arranged at an interval of approximately 0.5λ. For example, the plurality of reception antenna elements 521 may be disposed in the transmission/reception antenna region and the reception antenna region in a number of approximately 2704.

Referring to FIG. 8, FIG. 9A, and FIG. 9B, the transmission/reception array antenna 800 of the present exemplary embodiment may include the plurality of transmission antenna elements 511, the plurality of reception antenna elements 521, the plurality of transmission beamforming elements 515 connected to the plurality of transmission antenna elements 511, and the plurality of reception beamforming elements 525 connected to the plurality of reception antenna elements 521.

The plurality of transmission antenna elements 511 and the plurality of transmission beamforming elements 515 may configure a transmission array antenna. The transmission array antenna may receive a transmission signal subjected to baseband signal processing and may transmit the transmission signal through a transmission beam to the satellite using the plurality of transmission antenna elements 511 steered by the plurality of transmission beamforming elements 515.

The plurality of reception antenna elements 521 and the plurality of reception beamforming elements 525 may configure a reception array antenna. The reception array antenna may receive a reception beam transmitted from the satellite through the plurality of reception antenna elements 521 steered by the plurality of reception beamforming elements 525.

The plurality of transmission antenna elements 511 and the plurality of reception antenna elements 521 may be linearly arranged at intervals not overlapping each other on the same plane or the same region of the first substrate 501, that is, on one surface of the first substrate 501.

Each of the plurality of transmission beamforming elements 515 may be disposed on the other surface of the first substrate 501. Each of the plurality of transmission beamforming elements 515 may be disposed so as to overlap placement positions of corresponding ones of the plurality of transmission antenna elements 511. In addition, according to an exemplary embodiment, each of the plurality of transmission beamforming elements 515 may be disposed on one surface of the second substrate 502 overlapping the first substrate 501, that is, on one surface of the second substrate 502 overlapping the other surface of the first substrate 501.

Each of the plurality of transmission beamforming elements 515 may be connected to each of the plurality of transmission antenna elements 511 through the plurality of contact holes 503. As illustrated in FIG. 9B, the plurality of contact holes 503 may be formed in the first substrate 501, and each of the plurality of contact holes 503 may include a conductive pattern. Each of the plurality of transmission antenna elements 511 may be electrically connected to each corresponding one of the plurality of transmission beamforming elements 515 through the conductive pattern of each of the plurality of contact holes 503.

Each of the plurality of reception beamforming elements 525 may be disposed on the other surface of the second substrate 502. Each of the plurality of reception beamforming elements 525 may be disposed so as to overlap a placement position of each of the plurality of reception antenna elements 521.

Each of the plurality of reception beamforming elements 525 may be connected to each of the plurality of reception antenna elements 521 through the plurality of pogo pins 540. As illustrated in FIG. 9B, a plurality of first through-holes 504 may be formed at positions corresponding to each of the plurality of reception antenna elements 521 in the first substrate 501, and a plurality of second through-holes 505 may be formed at positions corresponding to each of the plurality of reception beamforming elements 525 in the second substrate 502. Each of the plurality of first through-holes 504 and each of the plurality of second through-holes 505 may be formed at positions corresponding to each other. Each of the plurality of pogo pins 540 may be inserted into each of the plurality of first through-holes 504 and each of the plurality of second through-holes 505. Accordingly, each of the plurality of reception antenna elements 521 may be electrically connected to each of the plurality of reception beamforming elements 525 through each of the plurality of pogo pins 540.

As described above, the transmission/reception array antenna 800 of the exemplary embodiment may dispose the plurality of transmission antenna elements 511 and the plurality of reception antenna elements 521 on the same plane of the first substrate 501, and therefore the size of the communication node 400 including the transmission/reception array antenna 800 can be reduced. In addition, the transmission/reception array antenna 800 of the exemplary embodiment may linearly dispose each of the plurality of transmission antenna elements 511 and each of the plurality of reception antenna elements 521 at a uniform interval on the same plane so as not to overlap each other, and therefore each of the plurality of transmission antenna elements 511 and each of the plurality of reception antenna elements 521 can perform beam steering in up, down, left, and right directions by the transmission beamforming element 515 or the reception beamforming element 525.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A transmission and reception array antenna, comprising:
a plurality of transmission antenna elements and a plurality of reception antenna elements disposed on a first surface of a first substrate;
a plurality of transmission beamforming elements disposed on a second surface of the first substrate and connected to the plurality of transmission antenna elements; and
a plurality of reception beamforming elements disposed on a first surface of a second substrate overlapping the first substrate and connected to the plurality of reception antenna elements, the second surface of the first substrate being adjacent to the first surface of the second substrate.

2. The transmission and reception array antenna of claim 1, further comprising: a plurality of contact holes formed in the first substrate,
wherein each of the plurality of transmission beamforming elements is disposed to overlap at least one of the plurality of transmission antenna elements, and the plurality of contact holes connect each of the plurality of transmission beamforming elements and each of the plurality of transmission antenna elements.

3. The transmission and reception array antenna of claim 1, further comprising:
a plurality of through-holes formed at corresponding positions of the first substrate and the second substrate; and
a plurality of pogo pins each of which is inserted into each of the plurality of through-holes,
wherein each of the plurality of reception beamforming elements is disposed to overlap at least one of the plurality of reception antenna elements, and the plurality of pogo pins connect each of the plurality of reception beamforming elements and each of the plurality of reception antenna elements.

4. The transmission and reception array antenna of claim 1, wherein the plurality of transmission antenna elements are disposed on the first surface of the first substrate at a first interval, the plurality of reception antenna elements are disposed on the first surface of the first substrate at a second interval, and the plurality of reception antenna elements are disposed so as not to overlap the plurality of transmission antenna elements.

5. The transmission and reception array antenna of claim 1, wherein the plurality of transmission antenna elements operate in a frequency band different from a frequency band of the plurality of reception antenna elements.

6. A communication node comprising a transmission and reception array antenna for transmitting and receiving beams with a satellite, wherein the transmission and reception array antenna comprises:
a plurality of transmission antenna elements and a plurality of reception antenna elements disposed on a first surface of a first substrate;
a plurality of transmission beamforming elements disposed on a second surface of the first substrate and connected to the plurality of transmission antenna elements; and
a plurality of reception beamforming elements disposed on a first surface of a second substrate overlapping the first substrate and connected to the plurality of reception antenna elements, the second surface of the first substrate being adjacent to the first surface of the second substrate.

7. The communication node of claim 6, wherein the transmission and reception array antenna further comprises: a plurality of contact holes formed in the first substrate,
wherein each of the plurality of transmission beamforming elements is disposed to overlap at least one of the plurality of transmission antenna elements, and the plurality of contact holes connect each of the plurality of transmission beamforming elements and each of the plurality of transmission antenna elements.

8. The communication node of claim 6, wherein the transmission and reception array antenna further comprises:
a plurality of through-holes formed at corresponding positions of the first substrate and the second substrate; and
a plurality of pogo pins each of which is inserted into each of the plurality of through-holes,
wherein each of the plurality of reception beamforming elements is disposed to overlap at least one of the plurality of reception antenna elements, and the plurality of pogo pins connect each of the plurality of reception beamforming elements and each of the plurality of reception antenna elements.

9. The communication node of claim 6, wherein the plurality of transmission antenna elements are disposed on the first surface of the first substrate at a first interval, the plurality of reception antenna elements are disposed on the first surface of the first substrate at a second interval, and the plurality of reception antenna elements are disposed so as not to overlap the plurality of transmission antenna elements.

10. The communication node of claim 6, wherein the plurality of transmission antenna elements operate in a frequency band different from a frequency band of the plurality of reception antenna elements.
